(19) United States
(12) Patent Application Publication
(10) Pub. No.: US 2006/0028337 A1
(43) Pub. Date: Feb. 9, 2006

(54) Voice-operated remote control for TV and electronic systems

(76) Inventor: Qi P. Li, New Providence, NJ (US)

Correspondence Address: HDSL, 4331 STEVENS BATTLE LANE, FAIRFAX, VA, 22033, US

(21) Appl. No.: 11/199,895

(22) Filed: Aug. 9, 2005

Related U.S. Application Data
(60) Provisional application No. 60/600,302, filed on Aug. 9, 2004.

(51) Int. Cl. G08B 1/08

(52) U.S. Cl. 340/539.1

(57) ABSTRACT

The present invention is to provide a voice-operated handhold remote control to be used with home and office appliances, such as TV, projector, DVD/CD, VCR, sound system, and many others. A user can use voice commands through a remote control of this invention to execute control functions over the appliances. To reach the object, the remote control of the present invention comprises at least: (1) a button for both muting and push-to-talk; (2) a microphone or microphone array; (3) an automatic speech recognizer; (4) a digital signal microprocessor; (5) memory; and (6) a signal transmitter.

### CROSS REFERENCE APPLICATIONS

This application claims priority from U.S. Provisional Patent Application No. US60/600,320, filed on Aug. 9, 2004.

### FIELD OF INVENTION

The present invention relates to a handhold remote control for television (TV), cable box, set-top box, projector, VCR, DVD, CD, and similar electronic devices. More particularly, the invention relates to a handhold remote control which operates one or more than one designated devices by voice comments.

### BACKGROUND OF THE INVENTION

A handhold remote control is a standard device for TV, projector, cable box, set-top box, VCRs, DVD/CD players, and many home and office appliances. Throughout this application, a TV or projector will be used as the representative device for all other appliances, such as cable box, set-top box, DVD/CD players etc. A user can use the batterer-powered wireless handhold remote control to turn on or turn off the selected device, to switch the channels, to adjust the sound volume. The current remote control requires a user to press the corresponding key or a sequence of keys on the keypad of the remote control to invoke a control action of the designated appliance, such as change channel numbers, mute the sound, adjust volume, etc. The remote control converts the key input(s) into corresponding control commands in the format of radio frequency (RF) control signals, such as infrared (IR) or wireless signals, and transmits the control signals to the selected appliance. Thus, instead of getting up and walking up to the TV for changing channels or adjusting sound volume, a user can remotely execute these commands through the remote control with key input(s).

However, an handhold remote control has limited space for the keypad and the number of keys, while the designated appliance has more and more new functions and features which need to be controlled or set up by users; therefore, with the current key-input remote control design, a user has to push a sequence of keys on the keypad of the remote control to invoke a particular function for a selected appliance. In the foreseeable future, the design of appliances will be packed with more new functions in which a handhold remote control should be able to keep up with the trend and let a user has the ability to control these new added functions remotely. Unless the new remote control becomes a bulk size or the size of keys become very small, it is difficult to increase the number of keys on the keypad. Also, it is not easy for a user to remember different combination of key input sequences for different operations. Besides, it is not easy to press several keys in a sequence without making a mistake by pressing a wrong key during the operation. All these aforementioned reasons make a key-operated remote control become more cumbersome or inconvenient to be operated in the future.

If we can use human speech, voice commands, to control the operations of electronic systems, it will provide users with a natural and convenient alternative way to operate devices. Now by using the automatic speech recognition (ASR) technology a computer can convert human speech to text or control signals. Today's ASR system can be implemented in a handhold device, which provides acceptable accuracy when the vocabulary size of voice commands is not very large and when users talk closely enough to the microphone in an environment without much background noise. However, most of remote controls are used in the front of TVs or other noisy environments and a user cannot or does not want to wear a headset with a close-talking microphone or talk very closely to a microphone while using handhold remote controls. There is a need for a voice-operated remote control which is easy to use and works reliably in the front of a TV or a loudspeaker.

### SUMMARY OF THE INVENTION

An object of the present invention is to provide a voice-operated handhold remote control to be used with home and office appliances, such as TV, projector, DVD/CD, VCR, sound system, and many others. A user can use voice commands through a remote control of this invention to execute control functions over the appliances.

To reach the object, the remote control of the present invention comprises at least: (1) a button for both muting and push-to-talk; (2) a microphone or microphone array; (3) an automatic speech recognizer; (4) a digital signal microprocessor; (5) memory; and (6) a signal transmitter.

### BRIEF DESCRIPTION OF THE DRAWINGS

The drawings disclose an illustrative embodiment of the present invention which serves to exemplify the various advantages and objects hereof, and are as follows:

FIG. 1 is a functional block diagram of the present invention.

FIG. 2 is a logical flowchart to illustrate the operations of the invention.

### DETAILED DESCRIPTION OF THE PREFERRED EMBODIMENT

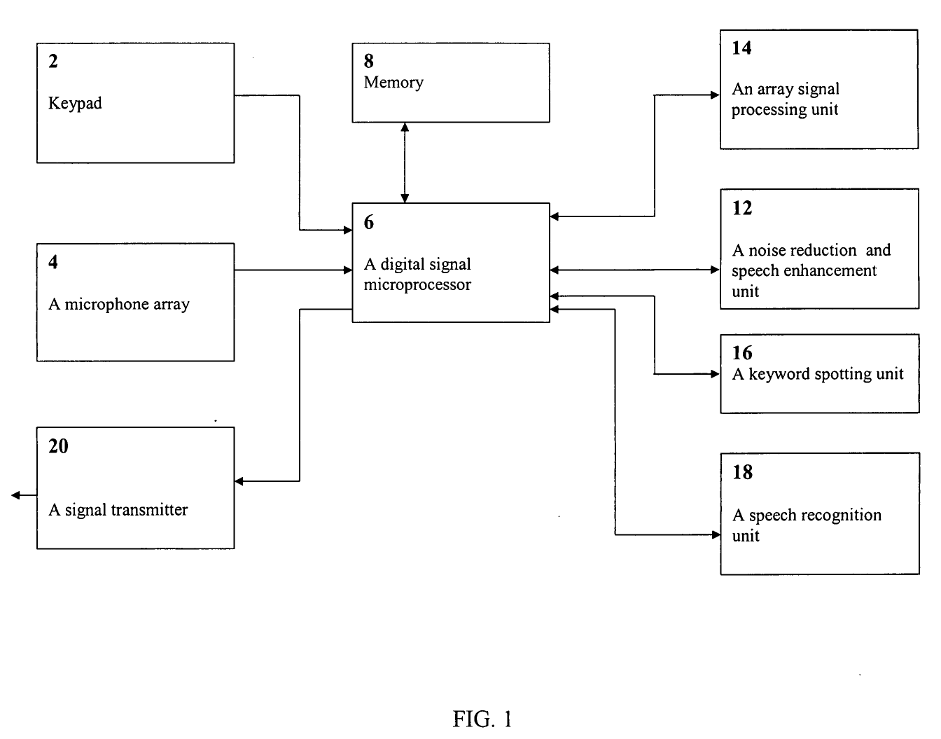

FIG. 1 illustrates an example of a functional block diagram of the present invention. The keypad 2 is for key input, and a microphone or microphone array 4 is for voice input. In addition, there are a digital signal microprocessor 6, memory 8 (read-only, random-access or flash memory as needed), a noise-reduction unit (NRU) 12, an array signal processing unit (ASPU) 14, a keywork spotting unit (KSU) 16, a speech recognition unit (SRU) 18, and a signal transmitter 20, where the keypad, the microphone/microphone array, the memory, the NRU, the ASPU, the KSU, the SRU, and the signal transmitter are all coupled to the digital signal microprocessor.

Because the remote control of the invention has the hardware, such as the keypad, the microprocessor, the memory, and the signal transmitter, it can work in either the voice control mode or the traditional key-input mode. When the current invention is in the key-input mode, it works as a traditional remote control. To invoke to the voice control mode, a user just needs to push and hold a dedicated push-to-talk and mute button and utters one or more control commands, and then releases the button when finishes the voice input. The dedicated button has two functions: First, it turns on the voice-operated mode and wakes up the speech recognition process; and second, the remote control through its signal transmitter sends out a “mute” command in corresponding radio frequency (RF) signals to the designated appliance(s) that will turn the designated appliance(s) into a mute mode.

While in the voice-operated mode, the voice-operated remote control turns on the built-in automatic speech recognizer, and the system starts to recognize the input voice commands received from the user. When a user wants to control a TV, e.g. to change a TV channel, the user pushes and holds the dedicated key for both muting and push-to-talk. The user says a channel number or channel name, for example “channel 150” or “CNN”, and then release the button. Here, the mute key has two functions: Firstly, the remote control sends a “mute” signal command to the TV and put the TV into a mute mode, which the sound from TV's loudspeakers is off, so there is not background sound/noise from the TV while the user is uttering a voice command. Secondly, the button can simultaneously trigger the ASR system as a push-to-talk button. The controlled appliance can be selected by voice command or can be selected by intelligent function in the processor. For example, a changing channel command must be for a TV or a cable box.

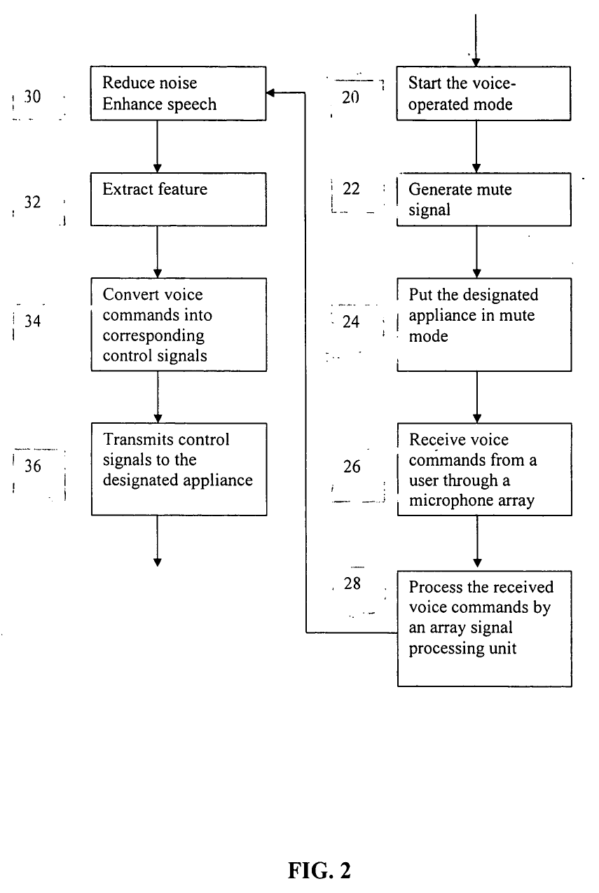

Referring to FIG. 2, by pushing and holding down the mute and push-to-talk key in step 20, The mute signal is generated and sent out through the signal transmitter from the remote control to the designated appliance, TV in this case. The signal can be in any frequency bands, such as infrared, Wi-Fi band, or other wireless signal bands to mute the TV or other appliances. The purpose is to reduce the background noise, so that a user can issue voice commands with better SNR Steps 22, 24.

The push-to-talk function has the following advantages: Firstly, the ASR system will be invoked only when the button is pushed; therefore, the ASR system does not pick unrelated voice signals to avoid miss operation and to save the battery power in process these unintended signals. Secondly, by pushing the push-to-talk button when a user is ready to say a voice command can reduce the length of recorded silence between voice commands; thus, it can speed up the speech recognition process and improve the recognition performance.

Once voice commands, analog signals, are collected by the microphone array which includes one or more than one microphone and each of the microphone components is coupled with a analog-to-digital converter (ADC), the ADCs convert the received analog voice signals into digital signals and forward the outputs to an array signal processing unit, where the multiple channel of speech signals are further processed using an array signal processing algorithm and the output of the array processing unit is one channel of speech signals with improved signal-to-noise ratio (SNR) (Step 28). Many existing array signal processing algorithm, such as the delay-and-sum algorithm, filter-and-sum algorithm, or others, can be implemented to improve the SNR of the signals. The delay-and-sum algorithm measures the delay on each of the microphone channels, aligns the multiple channel signals, and sums them together at every digital sampling point. Because the speech signal has very large correlation at each of the channels, the speech signal can be enhanced by the operation. At the same time, the noise signals have no or less correlation at each of the microphone channels, when adding the multiple-channel signals together, noise signals can be cancelled or reduced. The filter-and-sum algorithm is more general than the delay-and-sum algorithm which has one digital filter in each input channel plus one summation unit. In our invention, the array signal processor can be a linear device or a nonlinear device. In the case of a nonlinear device, the filter can be implemented as a neural network or a nonlinear system and the device has at least one nonlinear function, such as the sigmoid function. The parameters of the filters can be designed by existing algorithms or can be trained in a data-driven approach which is similar to training a neural network in pattern recognition. In another implementation, the entire array signal microprocessor can be implemented as a neural network, and the network parameters can be trained by pre-collected or pre-generated training data.

Moreover, because the microphone array consists of a set of microphones that are spatially distributed at known locations with reference to a common point, the invention can implement an array signal processing algorithm, by weighting the microphone outputs, and an acoustic beam can be formed and steered along some specified directions of the source of the sound, e.g. speaker's mouth. Consequently, a signal propagating from the direction pointed by the acoustic beam is reinforced, while sound sources originating from directions other than the direction are attenuated; therefore, all the microphone components can work together as a microphone array to improve the signal-to-noise ratio (SNR). The output of the digital array signal microprocessor is one-channel digitized speech signal where the SNR is improved by an array signal processing algorithm.

For different tasks and applications, the microphone components can be placed at different locations, and the number of microphone components can be various. Correspondingly, different array or multiple-channel signal processing algorithms can be implemented for the best performance. Any shape of configuration and any number of microphone components can be used in the remote control as long as they can improve the SNR.

Referring back to FIG. 2, the single channel speech signals outputted from the array signal processing unit are then forwarded into a noise-reduction and speech-enhancement unit Step 30 where the background noise is further reduced and the speech signal is enhanced simultaneously by a single-channel signal processing algorithm, such as spectral subtraction, Weiner filter, auditory-based algorithm, or any other algorithm which can improve the SNR with less or no distortion on the speech signals Step 30. The output of this unit is one channel enhanced speech signals.

Following the noise reduction/speech enhancement (Step 30), the next step is the feature extraction (Step 32). This step performed by the speech recognition unit 18 converts the digitized speech waveform into feature vectors for speech recognition. Usually, speech signals are converted from time domain into the frequency domain as spectrums or spectrograms by fast Fourier transform (FFT) or other suitable algorithms, and then the speech characteristics in the frequency domain are extracted to construct multi-dimensional data vectors as features. Depend on applications and algorithms, the noise reduction and speech enhancement unit 12 and the keyword spotting unit 16 can be combined into one unit, because the noise reduction, speech enhancement unit and the keyword spotting unit are tightly related to one another. It may save computation time if we combine them together.

The feature vectors generated from the patterns of speech phonemes or speech sub-words are compared with pre-trained acoustic models and pre-trained language models with constrains of a language grammar. Basically, the feature vectors of an uttered speech command are compared with all possible commands or words using a searching algorithm or detection algorithm, such as the Viterbi algorithm. The degree of match between the model and feature vectors is measured by computing likelihood score or other kind of score during searching. The search results are recognized control commands, such as channel numbers, channel names, or a sequence of words. Finally, the recognized control commands are then converted into radio frequency signals. The radio frequency signals are then transmitted to a TV or other electronic devices to control their operations Steps 34, 36.

The speech recognizer in the remote control can also have a so called keyword spotting function which can find and extract the key-command words from a sentence. For example, a user may say: “I want Channel 20 tonight”. The keyword-spotting function in the recognizer can catch Channel 20 as the key command and send a control signal out to set the TV to channel 20, where “channel” and “twenty” are two keywords.

The transmitting control signals can be in any frequency bands, such as in infrared bands, Wi-Fi, or any wireless signal bands. The signals can be transmitted to TV or other electronic equipment or systems directly, or through a wireless or computer network. The transmitted information can be coded as different radio frequencies, binary codes, or even text messages.

The control commands signals sending out by the current invention are the same whether the control commands are initialized through voice input or key-input. For example, to change TV channels, a user can either use the traditional key-input method on the current invention or use a voice-input method to do the operation, the “change TV channel” control command signals sent by the remote control are exactly the same from either input methods. Because the voice-operated commands of the current invention generates the same control command signals as the corresponding key-input commands do, therefore, there is no need to modify the existing appliances which are designed to react to a traditional key-input remote control.

Although, for explanation purpose, the functionalities are divided into several functional blocks, in an actual implementation, several functional blocks can be combined together. For example, the noise reduce unit, the keyword spotting unit and the speech recognition unit can be combined together. Or the keyword spotting unit and the speech recognition unit can also be combined. Or the array signal processing unit and noise reduction unit can also be combined.

The present invention can be implemented as a new device. The invention can also be implemented in existing PDA (personal data assistant), wireless phones, codeless phone, or any handheld device as a new and added function. In another embodiment, the invention can be implemented as a universal voice remote control which can control any appliances.

I claim:

1. A handheld battery-powered wireless remote control for appliances comprising:
a keypad which a user through key input can control a designated appliance in a keypad-operated mode;
a dedicated key in the keypad which can switch the remote control into a voice-operated mode in which a user through voice input can control the designated appliance;
a microphone device for receiving voice input;
a digital signal microprocessor;
a plurality of memories comprising RAM and ROM;
a radio-frequency transmitter;
a battery power source; and
while in the voice-operated mode, at the first, the radio-frequency transmitter will send a “mute” control signal to the appliance having loudspeaker that will be turned into a mute condition, then the digital microprocessor converts the voice input received by the microphone device into corresponding control signals, which are transmitted out to the designated appliance by the radio-frequency transmitter to control the operation of the designated appliance.

2. The remoter control as claimed in claim 1, wherein the microphone device is a microphone array comprises more than on microphone components.

3. The remoter control as claimed in claim 1, wherein the microphone device is a microphone.

4. The remoter control as claimed in claim 2, wherein the digital signal microprocessor further comprising:
a plurality of preamplifiers to amplify analog signals received from microphone components, where one preamplifier corresponds one voice signal channel;
an analogue-to-digital converter (ADC) to convert the received analogue signal to digital signal;
an array signal processor to convert received multiple-channel signals into single-channel signals which have improved signal-to-noise ratio (SNR);
a noise-reduction and speech enhancement unit to further improve the single-channel SNR;
a keyword-spotting unit for spotting voice commands from voice signals; and
a speech recognizer unit to convert the voice commands into one or a sequence of control operation codes or radio frequencies.

5. The digital signal processor as claimed in claim 4, wherein the array signal processor implements an array signal processing algorithm, such as a delay-and-sum algorithm, a filter-and-sum algorithm, a linear algorithm, or a nonlinear algorithm.

6. The array signal processor as claimed in claim 5, wherein the nonlinear algorithm of the array signal processor includes one or more nonlinear functions, such as a sigmoid function.

7. The digital signal processor as claimed in claim 4, wherein the noise reduction and speech enhancement algorithm is a Weiner filter algorithm to further reduce noise and enhance speech of the signals.

8. The digital signal processor as claimed in claim 4, wherein the noise reduction and speech enhancement algorithm is an auditory-based algorithm to further reduce noise and enhance speech of the signals.

9. The digital signal processor as claimed in claim 4, wherein the keyword-spotting unit further comprising acoustic models representing phonemes, sub-words, keywords, and key-phrases which need to be sorted, a garbage model representing all other acoustic sounds or units, and a decoder which can detect keywords or commands from voice signals through searching and using the models.

10. The digital signal processor as claimed in claim 4, wherein keyword-spotting unit and the speech recognizer unit further comprising:
a feature extracting unit to convert time-domain speech signal into frequency-domain features for recognition;
a language model to model the statistical property of spoken languages to help in search and decoding;
a set of acoustic models to model acoustic units: phonemes, sub-words, words, or spoken phrases, where the model can be a hidden Markov model to model the statistical property; and
a decoder converting a sequence of speech features into a sequence of acoustic units by searching, and then mapping the recognized acoustic units to the text of control commands, control codes, or a sequence of numbers of radio frequency.

11. The digital signal processor as claimed in claim 1, wherein the transmitter transmits the radio frequency to the receiver of appliances in a predetermined sequence of control commands signals which are equivalent to these control commands signals sent by the corresponding key-input operations.
